(19) United States
(12) Patent Application Publication
(10) Pub. No.: US 2009/0241725 A1
(43) Pub. Date: Oct. 1, 2009

(54) MODULARIZED PEDAL ASSEMBLY

(76) Inventor: Chung-I CHEN, Taichung Hsien (TW)

Correspondence Address: Chien-Hui Su, P. O. Box 70-121 Taichung, Taichung City, 40899, TW

(21) Appl. No.: 12/056,283

(22) Filed: Mar. 27, 2008

(51) Int. Cl. B62M 3/08

(52) U.S. Cl. 74/594.4

(57) ABSTRACT

A modularized pedal assembly includes an axial portion and a pedaling portion. The axial portion includes a spindle and a bush. The spindle is engaged to the bush. Each of two ends of the bush is formed with at least one protruding seat. Each pedaling portion has at least one combining space. The combining space is at one side of the pedaling portion and is extended inwards so that the pedaling portion is formed as an upper layer and a lower layer; and the pedaling portion is engaged to the protruding seats at two sides of the axial portion so that the pedaling portion is detachable from the axial portion. The pedal and crank are not detached frequently so as to retain the stability of the structure. The pedaling portion is replaceable and changeable to match the requirement of users and thus it is economic.

### FIELD OF THE INVENTION

The present invention relates to bicycles, and particularly to a modularized pedal assembly, wherein the pedal and crank are not detached frequently so as to retain the stability of the structure. The pedaling portion is replaceable and changeable to match the requirement of users and thus it is economic.

### BACKGROUND OF THE INVENTION

Bicycle has become a popular exercise currently because it can provide the function of leisure action and exercise. Other than driving for fun, driving bicycle also has the effect of promoting the spirit feeling. Furthermore, currently, many cities have provide many spaces for driving of bicycles so that driving bicycle has more and more popular and been accepted by people in cities or countries.

Other than comfort, the structure strength is main concern to the design of a bicycle. If not affect the appearance and steadiness, the parts of a bicycle are designed to be detachable.

In the Taiwan Patent No. 095201393, “The pedal and crank of a bicycle”, the structure of the bicycle includes a crank and a pedal. A lower end of the crank has a combining portion. The combining portion has a through hole which penetrates through the crank. The through hole has a tapered shape. The through hole has a large diameter portion and a small diameter portion. The connection of the small diameter portion and the large diameter portion has a tapered shape which is enlarged from the small diameter portion to the large diameter portion. The smaller diameter portion has an inner thread. A connecting rod is protruded from the pedal. The connecting rod has a small connecting section and a large connecting section. The connection of the large cambered sheet is reduced gradually toward the small connecting section so as to form a cambered inclined surface. The small cambered sheet has outer thread which is engageable to the inner thread of the small diameter portion.

From above description, it is known that the prior art is related to the combination of the pedal and crank. However a portion of the pedal of a bicycle contacting to the user's feet is the pedaling surface. In the prior art, the pedaling surface is integrally formed. If the pedaling surface is destroyed, the whole pedal must be replaced. It is not economic. Furthermore, the connection of the pedal and the crank of a bicycle is a bending section which directly suffers the force from the foot in operation. If it is detached and assembled frequently, the structure is easy to destroy and thus the lifetime is short.

Moreover, in prior art pedal, a cushion with threaded holes is added to the pedal and screws are used to enhance the locking strength. However the cushion and the pedal are design and made separately. This will increase the complexity of the pedal and the structure.

From above discussion, it is known that there is a necessity for a novel designed bicycle, in that the axial portion and pedal are detachable so that the pedal is replaceable. In replacement, the axial portion and crank is unnecessary to be detached so that the structure is retained well.

### SUMMARY OF THE INVENTION

Accordingly, the object of the present invention is to provide a modularized pedal assembly, in that the pedal and crank are not detached frequently so as to retain the stability of the structure. The pedaling portion is replaceable and changeable to match the requirement of users so as to have the fun in driving.

To achieve above object, the present invention provides a modularized pedal assembly including an axial portion and a pedaling portion. One end of the axial portion is a supporting section; and another end thereof is a combining section. A larger locking section is between the supporting section and the locking section. The combining section serves to assemble a crank of a bicycle. The supporting section serves for engaging a bush. The locking section serves to limit the bush from horizontal movement so that it only rotates radially. Two sides of the bush have a plurality of protruding seats. Each protruding seat has a penetrating threaded hole. The protruding seats and threaded holes serves for assembling the pedaling portion. A surface of each pedaling portion has a plurality of tips which are positioned corresponding to the threaded holes. A combining space is extended inwards from one inner side of the pedaling portion so that the pedaling portion is formed with an upper layer and a lower layer. By the combining space, the pedaling portion can be engaged to the upper and lower ends of the protruding seats. Lastly, a plurality of studs are used to lock the stud holes and the threaded holes.

The modularized pedal assembly of the present invention is more economic, steadier and more efficient than the prior art structure so that the pedals are not frequently detached from the crank. After the studs locking into the stud holes, the tips of the head of the studs will provide a slide proof effect to the bottom of the user so as to promote the driving effect of the bicycle.

Thus, as a whole, no cushion is used. The studs are used directly. The structure is easy and conveniently.

The various objects and advantages of the present invention will be more readily understood from the following detailed description when read in conjunction with the appended drawing.

### BRIEF DESCRIPTION OF THE DRAWINGS

FIG. 1 is an explosive schematic view of the modularized pedal assembly of the present invention.

FIG. 2 is a schematic perspective view of the modularized pedal assembly of the present invention.

FIGS. 3 to 6 are schematic views showing the embodiment of the pedaling portion of the modularized pedal assembly of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

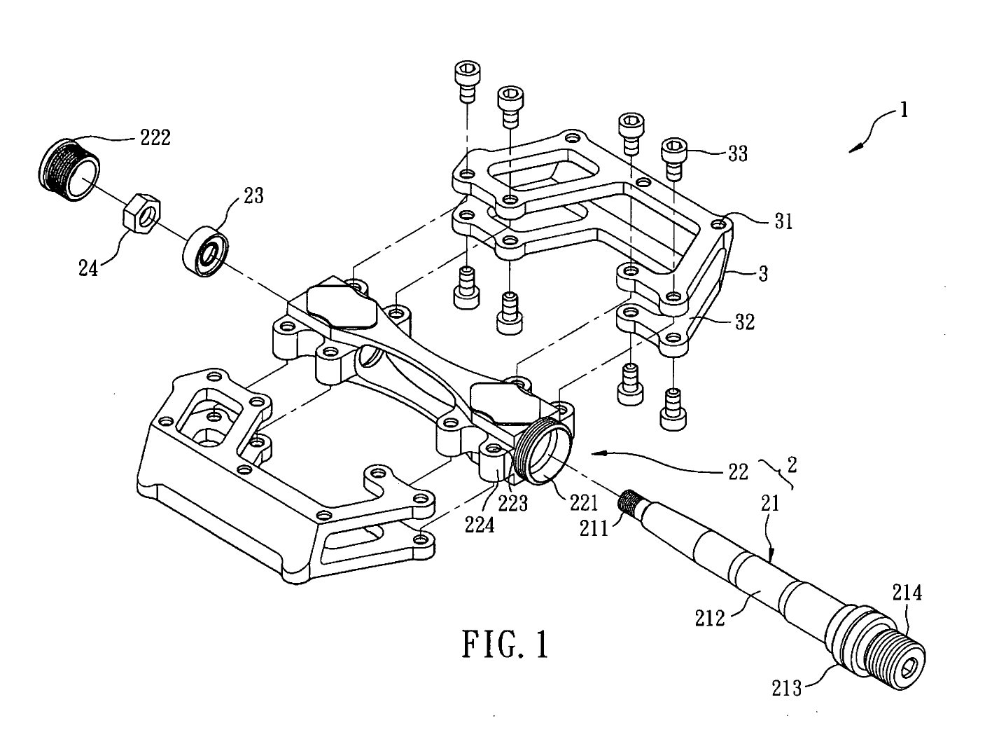

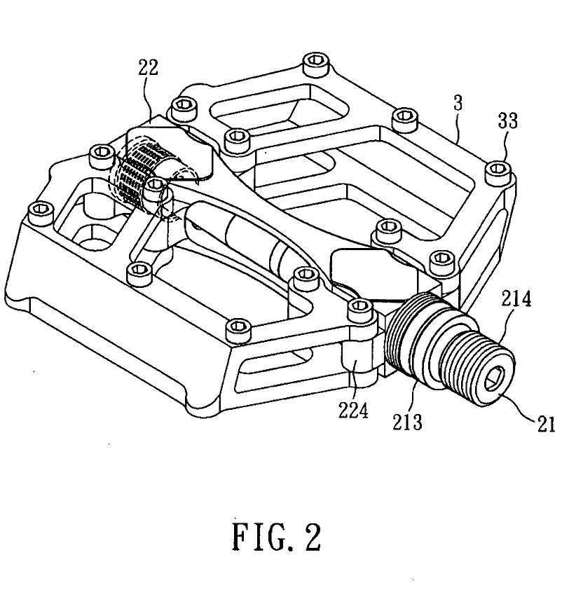

Referring to FIGS. 1 and 2, the modularized pedal according to the present invention is illustrated. The pedal 1 of the present invention has an axial portion 2 and a pedaling portion 3. The axial portion 2 is connected to the crank of a bicycle and a pedaling portion 3. The pedaling portion 3 serves to be pedaled by a rider.

The axial portion 2 has a spindle 21, a bush 22 and at least one bearing 23. The spindle 21 is combinable with the bush 22. The spindle 21 is sequentially formed with a locking section 211, a supporting section 212, a limiting section 213 and a combining section 214. The locking section 211 and the combining section 214 are threaded. The limiting section 213 has a greater diameter for resisting an object. The supporting section 212 is longer for installing the bearing 23. When the bush 22 is engaged to the spindle 21, the limiting section 213 resists against one end of the bush 22 for limiting the bush 22 from moving horizontally. The combining section 214 serves to be engaged to the crank of a bicycle. The axial portion 2 further has an inner limiting unit 24 for locking the spindle 21 and the locking section 211. Furthermore, it is limited in the bush 22 by using the inner limiting unit 24 to avoid the bush 22 from moving horizontally. Therefore, the bush 22 can rotate radially in the supporting section 212 through the bearing 23 without separating from the spindle 21.

The bush 22 of the axial portion 2 has a groove 221. One end of the groove 221 serves to receive the spindle 21 to be installed with the supporting section 212. Another end of the bush 22 is installed with a retaining cover 222 so that the whole structure is steadier. Under the condition that the bush 22 will not affect the structural strength of the present invention, partial structure can be holed so as to reduce the weight of the bicycle. Each of two ends of the bush 22 is formed with a plurality of protruding seats 223. Each protruding seats 223 has a penetrated threaded hole 224. By the protruding seats 223 being engaged to the pedaling portion 3 by locking screw into the threaded hole 224, the axial portion 2 is engaged to the pedaling portion 3 so that the body 1 is replaceable economically.

The pedaling portion 3 has combining spaces 32 so that the pedaling portion 3 is combined to the protruding seats 223 at two sides of the bush 22. The pedaling portion 3 is formed as an upper layer and a lower layer by the spacing of the combining spaces 32. A surface of the pedaling portion 3 has a plurality of stud holes 31 at a surface thereof and a plurality of studs 33. The number of the studs 33 is corresponding to that of the stud holes 31. The positions of the stud holes 31 are corresponding to the threaded holes 224. Some stud holes 31 are positioned corresponding to those of the threaded holes 224. Thus studs 33 pass through the stud holes 31 and the threaded holes 224 so as to retain the axial portion 2 to the pedaling portion 3. If not affect the strength of the pedaling portion 3, some portions of the pedal 1 can be hollowed so as to reduce the weight thereof.

The modularized pedal of the present invention is economic, steady and efficiency. To avoid to lock and detach the crank of the body 1, after the screws 33 are locked to the stud holes 31, the heads of the screws 33 are formed as tips on the surface of the pedal portion 3 so as to provide a slide-stop effect of the bottom of the foot.

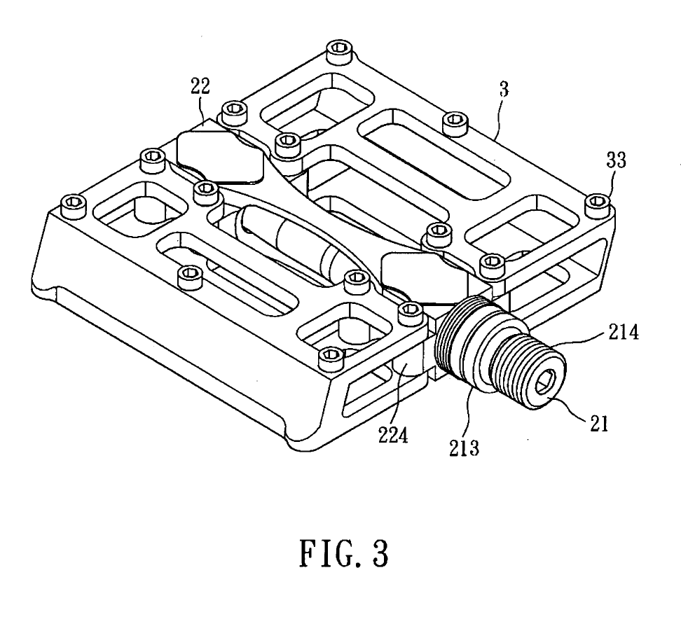

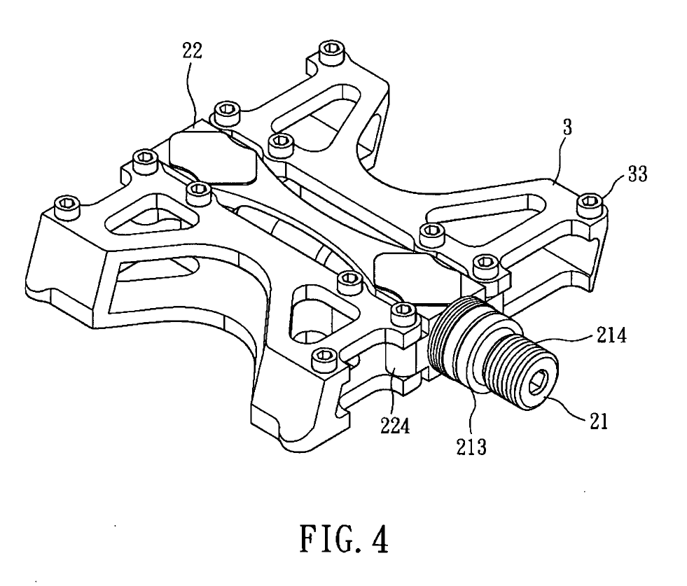

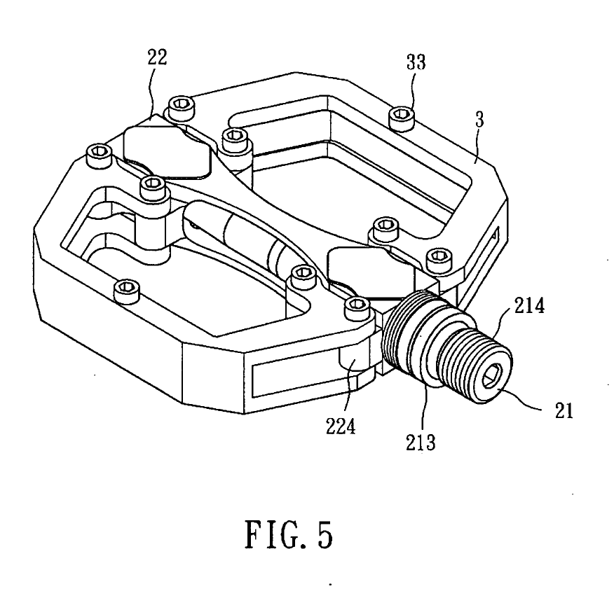

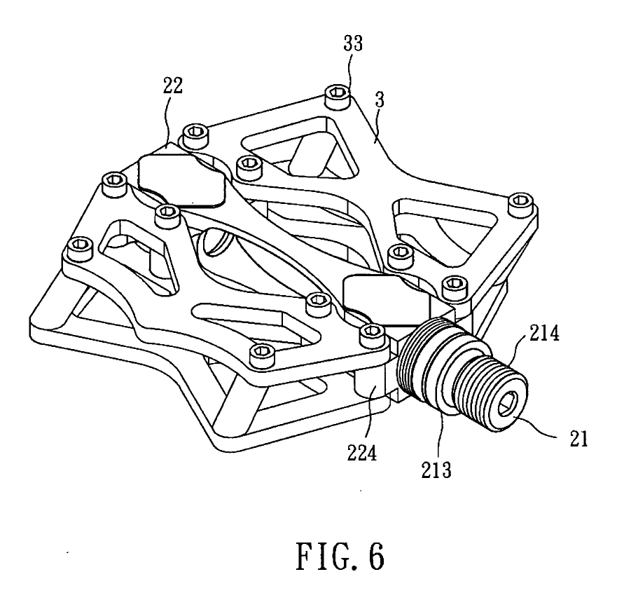

Referring to FIGS. 3 to 6, another embodiment about the pedaling portion 3 of the present invention, in that the pedaling portion 3 has various forms. It only needs to detach the screws 33 from the bearing 23, the pedaling portion 3 of other form can be locked thereinto. In FIG. 6, the upper layer and lower layer of the pedaling portion 3 are detachable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A modularized pedal assembly comprising an axial portion and a pedaling portion; wherein:
the axial portion includes a spindle and a bush; the spindle is engaged to the bush; each of two ends of the bush is formed with at least one protruding seat; each pedaling portion has at least one combining space; the combining space is at one side of the pedaling portion and is extended inwards so that the pedaling portion is formed as an upper layer and a lower layer; and the pedaling portion is engaged to the protruding seats at two sides of the axial portion so that the pedaling portion is detachable from the axial portion.

2. The modularized pedal assembly as claimed in claim 1, wherein the bush has a groove; and the spindle is sequentially formed with a supporting section, a limiting section and a combining section; the supporting section serves to engage with the groove; the limiting section serves to limit the bush not to move horizontally; and the combining section serves to install a crank of a bicycle.

3. The modularized pedal assembly as claimed in claim 1, wherein the protruding seat is formed with a penetrating threaded hole; and the pedaling portion has at least one stud hole and at least one stud; some stud holes are positioned corresponding to the threaded holes so that the studs can lock the protruding seat to the pedaling portion.

4. The modularized pedal assembly as claimed in claim 1, wherein one end of the spindle is installed with an inner limiting unit for avoiding the bush from horizontal movement.

5. The modularized pedal assembly as claimed in claim 1, wherein a surface of the stud has tips for providing slide proof effect.

6. The modularized pedal assembly as claimed in claim 1, wherein the upper layer and the lower layer of the pedaling portion are detachable.
